(19) United States
(12) Patent Application Publication
(10) Pub. No.: US 2020/0152166 A1
(43) Pub. Date: May 14, 2020

(54) MULTI-LAYER INSULATION WITH USE OF POLYIMIDE AEROGEL FILMS

(71) Applicant: ArianeGroup GmbH, Taufkirchen (DE)

(72) Inventor: Arturs JASJUKEVICS, Bremen (DE)

(21) Appl. No.: 16/678,489

(22) Filed: Nov. 8, 2019

(30) Foreign Application Priority Data
Nov. 8, 2018 (EP) 18205261.3

(51) Int. Cl. G10K 11/168; B32B 27/28; B32B 27/34; B32B 27/08; B32B 7/022; B32B 3/26

(52) U.S. Cl. CPC G10K 11/168; B32B 27/281; B32B 27/34; B32B 27/08; B32B 7/022; B32B 3/266; B32B 2307/416; B32B 2307/304; B32B 2307/732; B32B 2250/24; B32B 2305/02; B32B 2255/10; B32B 2307/102

(57) ABSTRACT

An insulation material for thermal and/or acoustic insulation. The insulation material comprises a plurality of layered sheets, including one or more flexible polyimide aerogel film/s being at least partially covered with a reflective coating on one or both of its surfaces. A method is provided for thermally and/or acoustically insulating an entity. The method comprises at least partially shielding, covering and/or enveloping the entity with an insulation material comprising comprises a plurality of layered sheets, including one or more flexible polyimide aerogel film/s being at least partially covered with a reflective coating on one or both of its surfaces.

### CROSS-REFERENCES TO RELATED APPLICATIONS

This application claims the benefit of the European patent application No. 18205261.3 filed on Nov. 8, 2018, the entire disclosures of which are incorporated herein by way of reference.

### FIELD OF THE INVENTION

The present invention concerns an insulation material for thermal and/or acoustic insulation, wherein the material comprises a plurality of layered sheets. The present invention further concerns a method for thermally and/or acoustically insulating an entity.

### BACKGROUND

The exchange of thermal energy between physical systems may rely on different physical conditions implying respective heat transfer modes such as thermal conduction (resulting on microscopic collisions of particles), thermal radiation (being an electromagnetic radiation) and convection (where heat is transported by means of a moving fluid).

Thermal insulation materials are devised to suppress heat transfer of one or more of such modes. To provide for a particularly high efficiency in insulation, the materials may comprise various layers which may have different properties so as to inhibit or reduce heat transfer according to a respective mode.

For example, multi-layer insulation (MLI) materials, which are composed of a plurality of layered sheets, are particularly adapted to reduce thermal radiation. These materials are often used for thermal control and protection of spacecraft and launch vehicles. The plurality of layers includes thin films of plastic, such as polyester films or polyimide films. These films are typically coated with a metal such as silver or aluminum. Due to the coating, these layers reflect a large portion of heat, while only a fraction of it passes on to the respective next layer.

Such MLI materials are lightweight as compared to other materials. They currently exhibit the best thermal performance in vacuum, where they act as a multi-layer radiative barrier. Depending on application, an MLI material can be able to reflect more than 99% of the incoming radiative heat flux.

Polyimide films offer the best performance in terms of thermo-mechanical stability and are able to operate at temperatures up to 450° C. Such films, however, are laborious in production and therefore expensive. Moreover, conventional MLI materials are usually effective only in vacuum, where convection and conduction are negligible. In a gaseous atmosphere, they have little impact. Besides, MLI materials including polyimide films are subject to the “International Traffic in Arms Regulations” (ITAR), such that the application and trade thereof is complicated and restricted.

Document US 2017/326849 A1 discloses laminate panels including a polyimide-based aerogel layer which is fiber-reinforced to improve its mechanical strength.

### SUMMARY OF THE INVENTION

It is an object of the present invention to provide an alternative insulation material and an alternative method of insulating, so as to overcome the above disadvantages.

An insulation material according to the present invention serves to provide thermal and/or acoustic insulation. It comprises a plurality of layered sheets including at least one flexible (i.e., bendable) polyimide aerogel film. Therein, the polyimide aerogel film is at least partially (i.e., in at least a portion of one or of both of its (opposite) surfaces) covered with a coating which is reflective to thermal radiation; in the following, this property is abbreviated by the expression “at least partially coated”.

According to advantageous embodiments, the coating covers at least 50%, at least 75%, at least 90% or even 100% of the respective surface area. Preferably, the coating comprises a metal, in particular aluminum, silver and/or gold. For example, to provide for the coating, the respective surface may be metalized (e.g., by applying a physical vapor deposition method), such that the polyimide aerogel acts as a substrate for metallization.

Like conventional metalized polyimide films traditionally included in certain insulation materials, such flexible and at least partially coated polyimide aerogel film provides for heat reflection.

A method according to the present invention serves for thermally or acoustically insulating an entity; in this document, the term “entity” may, in particular, refer to an object or to a creature, such as a person. The method comprises partially or entirely shielding, covering and/or enveloping the entity with an insulation material according to an embodiment of the present invention.

Compared to conventionally used insulation materials such as MLI materials based on (conventional) polyimide films, polyimide aerogel provides an extremely low thermal conductivity and a little mass per volume. As a consequence, the present invention provides for an insulation material exhibiting an advantageous ratio of insulation performance and mass. Moreover, polyimide aerogel operates as a sound absorber.

In particular, by configuring the polyimide aerogel with a respective porosity, the insulation material according to the present invention can be configured to have a lower mass than a conventional insulation material (such as a conventional MLI material) having the same or even an inferior insulation performance as the inventive insulation material, or it may be configured to have a better insulation performance than a conventional insulation material having the same or even a higher mass.

An insulation material according to the present invention has a wide range of applicability, as it efficiently insulates both in gaseous environments, where the polyimide aerogel can act as a classical insulator (such as a foam or felt), and under vacuum conditions. Therefore, in its various embodiments, an insulation material according to the present invention can be utilized in miscellaneous fields, for example, in aerospace, aviation, civil engineering and automotive engineering as well as in the fields of cryogenics and the provision of functional clothing. The entity insulated according to the inventive method may be a component pertaining to one or more of the fields.

For example, according to preferred embodiments, the insulation material according to the present invention is configured to be used to at least partially cover or envelop a component such as an aviation engine, elements of a hypersonic vehicle, an engine of a vehicle, a cryogenic vessel (in particular, a fuel tank of a spacecraft). In respective embodiments of the method according to the present invention, the entity is such a component.

Moreover, the insulation material according to the present invention may be used as a material for spacesuit and/or for clothes to be used in other extreme environments, e.g., for a firefighter suit or for alpine gear. In respective embodiments of the method according to the present invention, the entity may be a creature, in particular a person.

The polyimide included in the plurality of layered sheets including the polyimide aerogel may be a polymer of imide monomers. In embodiments comprising a plurality of such sheets, the respectively comprised polyimide aerogels may be equal, or at least two of these sheets may comprise different polyimide aerogels.

To allow for air passage, at least one of the plurality of layered sheets, in particular at least one sheet comprising polyimide aerogel (such as the one or more at least partially coated polyimide aerogel film) or—if present—sheets comprising a conventional polyimide film may be perforated.

As is to be understood, each of the terms “at least one of the plurality of layered sheets” and “at least one of the one or more flexible, at least partially coated polyimide aerogel film/s” as used in this document may, in respective combined embodiments, refer to different sheets/films each having a respective property or to a sheet/film having various of the properties respectively mentioned.

According to a preferred embodiment of the present invention, the insulation material is flexible. It may be configured as a blanket. Accordingly, the insulation material can be easily handled (e.g., folded, gathered and/or sewed) and utilized, such as for at least partially enveloping an element.

In particular, the insulation material may be configured as an MLI material. According to an embodiment, the insulation material comprises at most 100, at most 70 or at most 50 layered sheets. Additionally or alternatively, it may comprise at least 3, at least 6, at least 12 or at least 18 sheets.

The insulation material according to the present invention may comprise, as at least one of the plurality of layered sheets, a (conventional) polyimide film which may be at least partially metalized. In such case, the insulation material thus comprises both the one or more at least partially coated flexible films comprising polyimide aerogel and the at least one conventional polyimide film. Such embodiments may be advantageous depending on the respectively intended application, as they exhibit advantageous properties of the polyimide aerogel, may have a particularly small thickness and/or may include a particularly high number of layered sheets.

Additionally or alternatively, the insulation material according to the present invention may comprise, as an outmost layer constituting at least a portion of one or both surfaces of the material, a protective cover being a fabric layer or a film layer. The protective cover may be made of polyethylene terephthalate (PET), polyether ether ketone (PEEK) and/or polyimide, and/or it may comprise ceramic fibers or aramid fibers. The protective cover may be configured to protect the insulation material, such as—in respective applications—against damages due to collisions with micrometeorites or orbital debris (MMOD).

In cases where the insulation material comprises such one or more protective film layer(s) comprising polyimide, this (outmost) layer(s) may be the only layer(s) of the insulation material which include/s a conventional polyimide film, or at least one further conventional polyimide film may be included.

In such embodiments comprising a conventional polyimide film, a thickness thereof preferably is at least 8 μm, as such films are currently not subject to ITAR restrictions.

According to an alternative advantageous embodiment, the inventive insulation material is devoid of any (conventional) polyimide films. As ITAR does not cover polyimide aerogel, the latter embodiment facilitates a freely applicable and advantageous alternative to materials such as traditional MLI materials.

The insulation material according to the present invention may comprise, as one or more of the plurality of layered sheets, at least one spacer sheet. Such spacer sheet is adjacent (i.e., neighboring) to each of two further sheets and arranged between the further sheets, where it inhibits thermal contact of the two sheets.

At least one of the one or more spacer sheets may be a conventional spacer sheet. It may be made of a fabric such as gauze and/or cloth scrim, and/or it may include glass fibers, plastic fibers, and/or natural fibers.

Additionally or alternatively, at least one of the one or more spacer sheets may comprise aerogel. It may be uncoated at least in a surface region facing a coated region of one of the two adjacent sheets, or it may be at least partially covered with a reflective coating. In particular, the at least one spacer sheet may be (the) one of the one or more at least partially coated flexible polyimide aerogel films. The coating may comprise at least one region having an uneven surface, e.g., maintaining elevations and/or depressions in the surface of the polyimide aerogel: Such uneven surface may provide for interspaces between the spacer sheet and a respective neighboring sheet, so as to inhibit or at least reduce thermal contact. The coating may comprise a metal (e.g., aluminum, silver and/or gold) applied by physical vapor deposition. The (coated or uncoated) spacer sheet may be shaped as a grid including a plurality of cut-outs; if so, the total area of the cut-outs is preferably at most ⅓ or at most ½ of the total area extension of the spacer sheet.

Such embodiments facilitate particularly low areal density (mass per surface area). Moreover, they exhibit a particularly low heat transfer coefficient (HTC). Due to a buffer effect of the polyimide aerogel included in the spacer sheet, these embodiments provide a better protection against micrometeorites and orbital debris (MMOD) than conventional MLI materials.

In particular, any spacer included in the insulation material may be such spacer sheet (comprising polyimide aerogel), such that the insulation material is devoid of any conventional spacer, or the insulation material may include both types of spacers (i.e., at least one conventional spacer sheet and at least one spacer sheet comprising polyimide aerogel). For example, the insulation material may include at least one first sheet and at least one second sheet both acting as a spacer. The at least one first sheet may be positioned more at a side of the insulation material where radiation dominates than the at least one second spacer sheet. The at least one first sheet may then be conventional, whereas the at least one second sheet is a spacer sheet (comprising polyimide aerogel), or vice versa. The insulation material may thus be particularly adapted to conditions of its respective intended utilization.

According to a preferred embodiment of the present invention, at least one of the one or more flexible and at least partially coated polyimide aerogel film/s has a mean thickness of at least 8 μm, at least 15 μm or at least 35 μm. Additionally or alternatively, (the) at least one of the plurality of layered sheets may have a mean thickness of at most 1 mm, at most 0.7 mm, at most 0.3 mm, at most 75 μm or at most 60 μm. As expressed above with respect to the term “at least one of the one or more flexible and at least partially coated polyimide aerogel film/s,” in respective embodiments, the sheet having a mean thickness in the mentioned ranges may, in particular, be at least one at least partially coated aerogel film and/or the at least one spacer sheet.

Having a mean thickness in the range, the sheet comprising polyimide aerogel exhibits very low heat conductivity and is particularly lightweight. Depending on the respective application, a large number of layered sheets may be advantageous as long as the total thickness of the material does not exceed a certain maximum, which may be achieved with the upper limits of the thickness.

At least one of the one or more flexible and at least partially coated polyimide aerogel film/s may have an essentially uniform thickness at least throughout a zone of the sheet. Such sheet is easy to produce and may, in combination to the further sheets, provide for a uniform thickness of the insulation material.

Additionally or alternatively, at least one of the one or more flexible and at least partially coated polyimide aerogel film/s may include at least two zones with different respective (mean) thicknesses. The thickness may vary so as to form an insulation material which on the whole likewise may have a non-uniform thickness, as may be in accordance with a respective application of the insulation material. Additionally or alternatively, the at least one film may include one or more main zone/s and, in at least one particularly stressed region, a respective strengthened zone/s, wherein the at least one strengthened zone has a larger (mean) thickness than the main zone/s. The insulation material may thus be particularly robust.

Preferably, such zones each have an extension of at least 1 cm2, at least 25 cm2, at least 100 cm2 or at least 400 cm2.

The one or more at least partially coated flexible polyimide aerogel films may have an essentially uniform porosity at least throughout a portion of the respective film. Such sheet is easy to produce and may, in combination to the further sheets, provide for uniform insulation properties of the insulation material.

Additionally or alternatively, at least one of the one or more at least partially coated flexible polyimide aerogel films may include at least two portions/regions differing from each other by respective porosities of the comprised polyimide aerogel. For instance, the porosity may vary so as to form an insulation material having a non-uniform insulation property, as may be in accordance with a respective application of the insulation material.

Preferably, such regions each have an extension of at least 1 cm2, at least 25 cm2, at least 100 cm2 or at least 400 cm2.

The one or more at least partially coated flexible polyimide aerogel films included in the insulation material may all have essentially a same mean thickness and/or porosity. This allows for a simple fabrication of the insulation material and a universal applicability thereof.

According to an advantageous embodiment of the present invention, two or more of at least partially coated flexible polyimide aerogel films differ from each other with regard to their respective mean thickness and/or the porosity (of the respectively comprised polyimide aerogel).

For instance, the insulation material may comprise at least two spacer sheets comprising polyimide aerogel as mentioned above, wherein a first one of the spacer sheets has another mean thickness and/or porosity than a second one. Analogously, the insulation material may (additionally or alternatively) comprise two or more at least partially coated flexible polyimide aerogel films having different mean thicknesses and/or porosities. As a further possibility, the insulation material may include at least one spacer sheet and one or more at least partially coated flexible polyimide aerogel films, wherein the spacer sheet(s) has/have another mean thickness and/or porosity than the at least partially coated flexible sheet(s).

Thereby, a concept of varying densities of the insulation material is easy to implement: The sheets of different thicknesses and/or porosities may be arranged, in the insulation material, according to a respective application thereof.

For instance, the insulation material may include at least one first at least partially coated flexible polyimide aerogel film and at least one second at least partially coated flexible polyimide aerogel film. The at least one first at least partially coated flexible polyimide aerogel film may be positioned at a side of the insulation material where (in application) radiation dominates, whereas the at least one second at least partially coated flexible polyimide aerogel film may be arranged at a side where (in application) conduction dominates. To allow further mass optimization, the at least one first film may then be thinner than the at least one second film. Alternatively, e.g., in cases where the multilayer insulation material serves as an external insulation for a launch vehicle when increasing thermodynamic loads occur, the at least one first film may preferably be thicker than the at least one second film. Additionally or alternatively, the polyimide aerogel included in the first film may have a smaller or a higher mean porosity than the polyimide aerogel included in the second film.

### BRIEF DESCRIPTION OF THE DRAWINGS

In the following, preferred embodiments of the present invention are explained with respect to the accompanying drawings. As is to be understood, the various elements and components are depicted as examples only, may be facultative and/or combined in a manner different than that depicted. Reference signs for related elements are used comprehensively and are not defined again for each figure.

Shown is schematically in

FIG. 1 is a portion of a first exemplary embodiment of an insulation material according to the present invention;

FIG. 2 is a portion of a second exemplary embodiment of an insulation material according to the present invention;

FIG. 3 is a portion of a third exemplary embodiment of an insulation material according to the present invention;

FIG. 4 is a portion of a fourth exemplary embodiment of an insulation material according to the present invention; and

FIG. 5 is a possible configuration of a spacer sheet.

### DETAILED DESCRIPTION OF THE PREFERRED EMBODIMENTS

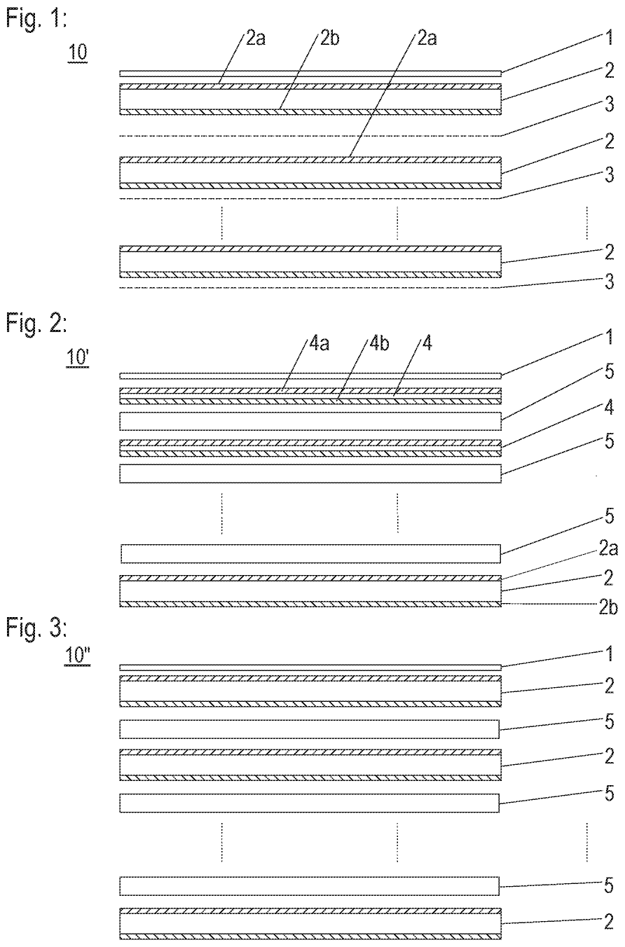

In FIG. 1, an insulation material 10 according to a first exemplary embodiment of the present invention is depicted in a sectional view. The insulation material 10 (as well as, analogously, insulation materials 10′, 10″, 10′″ shown in FIGS. 2, 3 and 4 and described below) serves to thermally and/or acoustically insulate a respective entity it may envelop, shield and/or cover. It is configured as an MLI material composed of a plurality of layered sheets.

An outmost one of the sheets is a protective cover 1. The protective cover 1 may be a film comprising PET, PEEK and/or polyimide, or it may be a fabric made of ceramic fibers and/or fiberglass, aramid fibers or any other fabric or coating appropriate for the application. It may serve to protect the insulation material, as well as to provide favorable thermo-optical properties for some applications. Preferably, the protective cover is configured to face, in application, an exterior environment of an enveloped, shielded and/or covered entity; according to a preferred embodiment of the inventive method, the insulation material 10 is arranged accordingly, with the cover fabric 1 facing outwards.

The insulation material 10 further comprises a plurality of layered sheets 2 and 3 of two types arranged alternately stacked. Three sheets 2 and 3 are respectively depicted, further ones may be included, as indicated, in the figure, by vertically arranged dots.

Sheets 2 are flexible polyimide aerogel films. In the shown example, at least in the portion depicted, each sheet 2 has a uniform thickness, and all sheets 2 have the same thickness. Such thickness may preferably be at least 8 μm, at least 15 μm or at least 35 μm, and/or at most 1 mm, at most 0.7 mm, at most 0.3 mm, at most 75 μm or at most 60 μm.

On both of their respective opposite surfaces, the sheets 2 have a coating 2a, 2b reflective to thermal radiation, such as metal, in particular aluminum, silver and/or gold. The coating may, for instance, be applied by means of a physical vapor deposition method.

Sheets 3 further included in the insulation material 10 are conventional spacers configured to inhibit thermal contact of adjacent sheets 2, in particular to inhibit physical contact of the coatings 2a, 2b of respective corresponding sheets 2 facing the respective sheet 3.

In comparison to a conventional MLI material, the sheets 2 comprising a polyimide aerogel film replace conventional PET, PEEK, polyimide or other films. As a consequence, the insulation material 10 can be constructed with less weight and a lower heat transfer coefficient than a conventional MLI material with the same number of layers.

At the surface opposite to the protective cover 1, the insulation material 10 might comprise a further protective cover (not shown), which may be a protective film (e.g. comprising PET, PEEK or polyimide). Such protective cover may be at least partially coated with reflective coatings on one or both of its surfaces.

In FIG. 2, an insulation material 10′ according to an alternative embodiment of the present invention is shown, which is likewise configured as an MLI material composed of a plurality of layered sheets. It includes a protective cover 1 which may have the properties and which may be used as described above with respect to FIG. 1.

Moreover, the insulation material 10′ comprises conventional sheets being polyimide films 4, which are at least partially coated, preferably metalized, e.g., with aluminum, silver and/or gold and/or by application of a physical vapor deposition method.

Additionally, the insulation material 10′ comprises at least one sheet 2 being a flexible, at least partially coated polyimide aerogel film as described with respect to FIG. 1.

In the exemplary embodiment shown in FIG. 2, sheets 5 comprise (or even consist of) polyimide aerogel, and they act as spacers inhibiting thermal contact of adjacent sheets 4, in particular to inhibit physical contact of the coatings 4a, 4b, 2b of respective sheets 4, 2 facing the respective sheet 5.

In the present case, the spacer sheets 5 each have a uniform thickness (in the shown portion), and all sheets 5 have the same thickness. Such thickness may preferably be at least 8 μm, at least 15 μm or at least 35 μm, and/or at most 1 mm, at most 0.7 mm, at most 0.3 mm, at most 75 μm or at most 60 μm.

As compared to conventional MLI materials, the insulation material 10′ may be constructed with an even lower areal density, and, due to the buffer effect of the spacer sheets 5, so as to provide a better protection against micrometeorites and orbital debris. Moreover, due to the low heat conductivity of the spacer sheets 5, it may exhibit a lower heat transfer coefficient than a traditional MLI material having the same number of layered sheets.

Again, at the surface opposite to the protective cover 1, the insulation material 10′ might comprise a further protective cover (not shown), as mentioned above with respect to FIG. 1.

In FIG. 3, a portion of a third embodiment of an inventive insulation material 10″ is shown. Further to a protective cover 1 (which may have the properties and which may be used as described above with regard to FIG. 1), the insulation material 10″ comprises sheets 2, 5 as described above, wherein the sheets are stacked alternatingly. Three sheets of each type are depicted, further ones may be included, as indicated, in the figure, by vertically arranged dots.

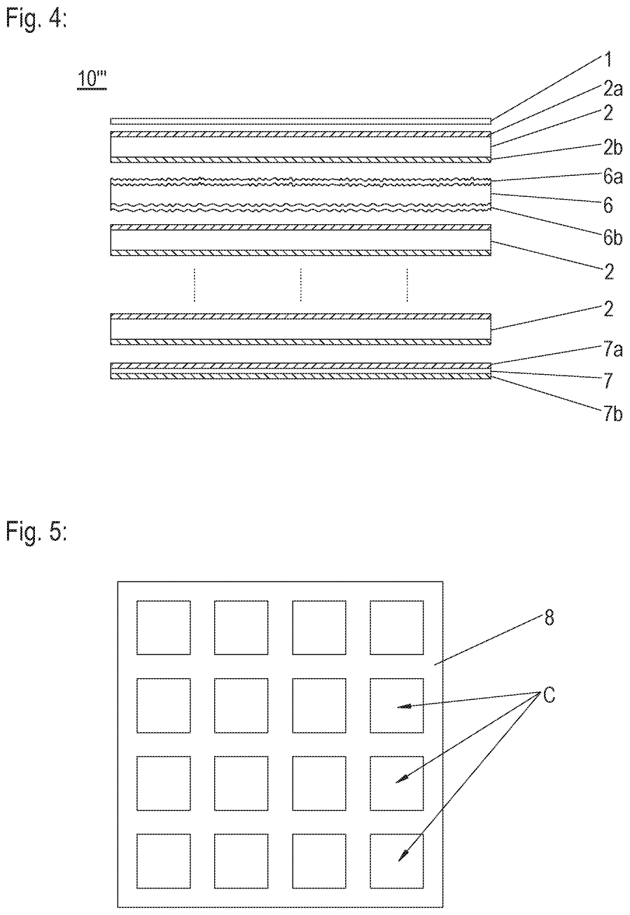

FIG. 4 shows a further insulation material 10′″ being an exemplary embodiment of the present invention. The insulation material 10′″ comprises a protective cover 1 and a plurality of at last partially coated flexible polyimide aerogel films 2 as described above with respect to FIG. 1.

At the surface opposite to the protective cover 1, the insulation material 10′″ comprises a further protective cover 7, which in the case depicted is a protective film (e.g., of PET, PEEK or polyimide). The protective cover 7 is at least partially coated with reflective coatings 7a, 7b on both of its surfaces.

The insulation material 10′″ further comprises at least one spacer sheet 6 comprising polyimide aerogel and reflective coatings 6a, 6b. Therein, the coatings 6a, 6b have an uneven surface, resulting from the coatings at least partially maintaining elevations and suppressions in the surface of the polyimide aerogel they cover. The unevenness provides for interspaces between the spacer sheet 6 and the respective neighboring sheets 2, which inhibit or at least reduce thermal contact.

The coatings 6a, 6b, 7a, 7b each may comprise a metal such as aluminum, silver and/or gold. Preferably, they may have been applied by physical vapor deposition.

FIG. 5 shows a plan view of a possible spacer sheet 8 comprising polyimide aerogel. The spacer sheet 8 comprises a plurality of cut-outs, three of which are exemplarily identified by reference sign C. In the exemplary embodiment depicted, the cut-outs are shaped as squares. As is to be understood, a spacer sheet may additionally or alternatively comprise cut-outs with one or more other geometric shape(s), such as disc(s). Preferably, a total area of the cut-outs is at most ⅓ or at most ½ of the total area extension of the sheet 8 (including the cut-outs). The cut-outs provide for interspaces between neighboring sheets and, therewith, for an improved reduction of thermal contact.

The spacer sheet 8 may be configured as each of spacer sheets 5 and 6 described above. In particular, it may be uncoated or at least partially covered with a reflective coating as described above.

Disclosed is an insulation material for thermal and/or acoustic insulation. The insulation material comprises a plurality of layered sheets including one or more flexible polyimide aerogel film/s being at least partially covered with a reflective coating on one or both of its surfaces.

Further disclosed is a method for thermally and/or acoustically insulating an entity. The method comprises at least partially shielding, covering and/or enveloping the entity with an insulation material according to an embodiment of the present invention.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCE SIGNS

1 protective cover
2 at least partially coated flexible polyimide aerogel film
2a, 2b coating of sheet 2
3 conventional spacer
4 conventional polyimide film
4a, 4b coating of sheet 4
5 spacer sheet comprising polyimide aerogel
6 spacer sheet comprising polyimide aerogel
6a, 6b coating of sheet 4
7 protective cover
7a, 7b coating of sheet 7
8 spacer sheet
10, 10′, 10″, 10′″ insulation material
C cut-outs in spacer sheet 8

1. An insulation material for at least one of thermal or acoustic insulation, comprising:
a plurality of layered sheets including one or more flexible polyimide aerogel films having a first and second surface with at least a partial cover of a reflective coating on one or both of the surfaces.

2. The insulation material according to claim 1, wherein at least one of the one or more flexible and at least partially coated polyimide aerogel films has a mean thickness of at most 1 mm.

3. The insulation material according to claim 1, wherein at least one of the one or more flexible and at least partially coated polyimide aerogel films has a mean thickness of at least 8 μm.

4. The insulation material according to claim 1, wherein at least one of the one or more flexible and at least partially coated polyimide aerogel films has a mean thickness of at most 60 μm.

5. The insulation material according to claim 1, wherein at least one of the one or more flexible and at least partially coated polyimide aerogel films has a mean thickness of at least 35 μm.

6. The insulation material according to claim 1, wherein at least one of the one or more flexible and at least partially coated polyimide aerogel films has an essentially uniform thickness at least throughout a zone of the film.

7. The insulation material according to claim 1, wherein at least one of the one or more flexible and at least partially coated polyimide aerogel films includes at least two zones of different respective mean thicknesses.

8. The insulation material according to claim 1, wherein at least one of the one or more flexible and at least partially coated polyimide aerogel films has an essentially uniform porosity at least throughout a portion of the respective sheet.

9. The insulation material according to claim 1, wherein at least one of the one or more flexible and at least partially coated polyimide aerogel films includes at least two portions with different respective porosities.

10. The insulation material according to claim 1, wherein the insulation material includes two or more sheets comprising polyimide aerogel, wherein the two or more flexible at least partially coated polyimide aerogel films have different mean sheet thicknesses.

11. The insulation material according to claim 1, wherein the insulation material includes two or more sheets comprising polyimide aerogel, wherein the two or more flexible at least partially coated polyimide aerogel films have different mean porosities.

12. The insulation material according to claim 1, wherein the plurality of layered sheets includes one or more spacer sheets comprising polyimide aerogel.

13. The insulation material according to claim 12, wherein at least one of the one or more spacer sheets is at least partially covered with a reflective coating on one or both surfaces, wherein the reflective coating comprises at least one region having an uneven surface.

14. The insulation material according to claim 12, wherein the one or more spacer sheets include at least one sheet shaped as a grid including a plurality of cut-outs, wherein a total area of the cut-outs is at most ½ of a total area extension of the sheet.

15. The insulation material according to claim 12, wherein the one or more spacer sheets include at least one sheet shaped as a grid including a plurality of cut-outs, wherein a total area of the cut-outs is at most ⅓ of a total area extension of the sheet.

16. The insulation material according to claim 1, wherein the insulation material is configured as a flexible Mil material.

17. A method for at least one of thermally or acoustically insulating an entity, the method comprising:
at least one of partially shielding, covering or enveloping the entity with an insulation material according to claim 1.
